(19) United States
(12) Patent Application Publication
(10) Pub. No.: US 2025/0256482 A1
(43) Pub. Date: Aug. 14, 2025

(54) FABRIC COMPRISING A NONWOVEN WEB OF FIBERS AND CORRESPONDING METHOD OF PRODUCTION

(71) Applicant: Glatfelter Gernsbach GmbH, Gernsbach (DE)

(72) Inventor: Jörg KÜHN, Ötigheim (DE)

(21) Appl. No.: 18/858,169

(22) PCT Filed: Jun. 1, 2023
(86) PCT No.: PCT/EP2023/064668

§ 371 Date: Oct. 18, 2024

(30) Foreign Application Priority Data
Jun. 9, 2022 (EP) 22178150.3

(51) Int. Cl. B32B 5/26; B32B 5/02; B32B 23/18

(52) U.S. Cl. CPC B32B 5/267; B32B 5/022; B32B 5/268; B32B 23/18; B32B 2262/04; B32B 2307/7163

(57) ABSTRACT

The present invention relates to a fabric comprising a plurality of fibers, wherein the plurality of fibers are made of a fiber material comprising a cellulose ether and wherein the plurality of fibers form a nonwoven web. The present invention further relates to a corresponding method of producing a fabric comprising a nonwoven web.

### FIELD OF THE INVENTION

The present invention relates to a fabric comprising a nonwoven web and a corresponding method of producing such a fabric. In particular, the present invention relates to biobased and/or biodegradable fabrics.

### BACKGROUND

Nonwoven fabrics are sheet or web structures bonded together by entangling fibers or filaments mechanically, thermally, or chemically. Nonwoven fabrics are made from a web of individual fibers which are at least partially intertwined, but not in a regular manner as in knitted or woven fabrics. Typically, a certain amount of recycled fabrics can be used in nonwoven fabrics and some nonwoven fabrics can be recycled after use, given the proper treatment and facilities. For this reason, nonwoven fabrics have been considered an ecological alternative to traditional knitted or woven fabrics, especially in fields and industries where disposable or single use products are important, such as food and beverage filtration, household cleaning, and air filtration.

Conventionally, synthetic fibers have been used in nonwoven fabrics, for example plastic fibers of polyethylene (PE), polypropylene (PP), or polyester such as polyethylene terephthalate (PET). However, these fibers and corresponding fabrics are not biobased, nor are they to sufficient extent biodegradable. Accordingly, concerns about plastic contamination of the environment have led to a demand for biobased and compostable materials suitable for forming fibers to be used in nonwoven fabrics.

Thus, there is a need for nonwoven fabrics and corresponding fibers, which are biobased and/or biodegradable.

### OBJECT OF THE INVENTION

The present invention aims at overcoming the above-described problems and drawbacks. Thus, it is an object of the present invention to provide a biobased and/or biodegradable material to serve as a basis or raw material for fibers in non-woven fabrics. These fibers and corresponding fabrics may be adapted to various applications such as food and beverage filtration, household cleaning and air filtration.

### SUMMARY OF THE INVENTION

The present inventors have made diligent studies and have found that this object can be solved by designing a fabric comprising a plurality of fibers, wherein the plurality of fibers are made of a fiber material, in particular a thermoplastic fiber material, comprising a cellulose ether, wherein the plurality of fibers form a nonwoven web. Without wishing to be bound to any theory, the present inventors assume that such a fiber material, possibly further comprising a biobased and/or biodegradable plasticizer and/or a biobased and/or biodegradable filler material, may be suitable for producing fibers to form a nonwoven fabric.

Accordingly, the present invention relates to a fabric comprising a plurality of fibers, wherein the plurality of fibers are made of a fiber material comprising a cellulose ether and wherein the plurality of fibers form a nonwoven web.

The present invention further relates to a fiber made of a fiber material comprising a cellulose ether.

The present invention further relates to a method of producing a fabric, wherein the method comprises the steps of (i) providing a fiber material comprising a cellulose ether, (ii) generating fibers from the fiber material, and (iii) arranging the fibers to form a nonwoven web.

The present invention further relates to a fabric obtainable by the method described herein.

Other objects and many of the attendant advantages of embodiments of the present invention will be readily appreciated and become better understood by reference to the following detailed description of embodiments.

### DETAILED DESCRIPTION OF THE INVENTION

Hereinafter, details of the present invention and other features and advantages thereof will be described. However, the present invention is not limited to the following specific descriptions, but they are rather for illustrative purposes only.

It should be noted that features described in connection with one exemplary embodiment or exemplary aspect may be combined with any other exemplary embodiment or exemplary aspect. For instance, features described with any exemplary embodiment of a fabric may be combined with any other exemplary embodiment of a fabric, with any exemplary embodiment of a method of producing a fabric and vice versa, unless specifically stated otherwise.

Where an indefinite or definite article is used when referring to a singular term, such as “a”, “an” or “the”, a plural of that term is also included and vice versa, unless specifically stated otherwise, whereas the word “one” or the number “1”, as used herein, typically means “just one” or “exactly one”.

In a first aspect, the present invention relates to a fabric comprising a plurality of fibers, wherein the plurality of fibers are made of a fiber material comprising a cellulose ether, in particular a thermoplastic material comprising a cellulose ether, and wherein the plurality of fibers form a nonwoven web.

The term “fabric”, as used herein, may particularly denote any material or structure comprising natural or synthetic fibers, or yarns, or both. A fabric may be a material partly or fully made through at least one of weaving and knitting. The fabric may also be or comprise a nonwoven fabric, which is produced by methods different from weaving and knitting. The fabric may consist of a single layer or may be a multilayered structure comprising for example two, three, four, five, or more than five layers, in particular more than ten layers or even more than a hundred layers.

The term “cellulose ether”, as used herein, may particularly denote a derivative of cellulose formed by partial or complete substitution of the hydrogen atoms of the hydroxy groups in cellulose. This reaction is called etherification. The cellulose ether may be at least one of ethyl cellulose (EC), methyl cellulose (MC), hydroxyethyl cellulose (HEC), hydroxypropyl cellulose (HPC), carboxymethyl cellulose (CMC), methylethyl cellulose (MEC), hydroxyethylmethyl cellulose (HEMC), hydroxypropylmethyl cellulose (HPMC), and ethylhydroxyethyl cellulose (OS-EHEC).

The term “non-woven web”, as used herein, may particularly denote a web of individual fibers which are at least partially intertwined or entangled, but not in a regular manner as in a knitted or woven fabric.

The term “fiber”, as used herein, may particularly denote a thread or a structure or object resembling a thread, for example a slender and elongated natural or synthetic filament. Fibers may, but need not be flexible. A “filament”, as used herein, may particularly denote a single thread or a thin threadlike object.

The fibers may be thermoplastic fibers. The term “thermoplastic fibers”, as used herein, may particularly denote fibers that soften and/or partly or even fully melt when exposed to heat. Thermoplastic fibers may be capable of binding or at least partly fusing with each other and/or with other material upon cooling and resolidifying.

Finding biobased materials suitable for producing fibers to form a nonwoven web or fabric is a challenging task. It has been found in experimental studies by the present inventors that, surprisingly, cellulose ethers constitute particularly adequate raw materials for forming fibers and corresponding nonwoven fabrics. Because fibers made of a material comprising a cellulose ether may have improved biodegradability compared with conventional fiber material, the corresponding fabric may have an improved ecological impact. In addition, nonwoven webs and fabrics are typically produced and/or recycled more easily and at less cost compared with knitted or woven fabric.

In an embodiment, the fabric or products made from the fabric are for use in food and beverage filtration, in particular for hot and cold extraction, i.e. to leach organic material such as ground coffee powder, tea leaves, tea leaf parts, herbs or spices with hot and/or cold liquids, for example water. Alternatively or in addition, the fabric may be for use in household cleaning, e.g. for wipes, which may be dry or moisturized. Alternatively or in addition, the fabric may be for use in air filtration, in particular heating, ventilation and air conditioning (HVAC) filters, which may be for industrial or residential applications, e.g. filter for air conditioning in cars, holes or buildings. The fabric may be adapted to specific requirements stemming from these applications.

In an embodiment, the cellulose ether is ethyl cellulose.

The term “ethyl cellulose”, as used herein, may particularly denote a derivative of cellulose or cellulosic derivative in which some or even all of the hydroxyl groups on the repeating glucose units are converted into ethyl ether groups. Ethyl cellulose may be a thermoplastic material. It has been found in experimental studies by the present inventors that surprisingly ethyl cellulose constitutes a particularly adequate raw material for forming fibers and corresponding nonwoven fabrics. Also, ethyl cellulose may be advantageous for applications such as food and beverage processing, air filtration, or household cleaning because it is biobased, biodegradable, and non-toxic.

In an embodiment, the cellulose ether is ethyl cellulose (EC), methyl cellulose (MC), hydroxyethyl cellulose (HEC), hydroxypropyl cellulose (HPC), carboxymethyl cellulose (CMC), methylethyl cellulose (MEC), hydroxyethylmethyl cellulose (HEMC), hydroxypropylmethyl cellulose (HPMC), ethylhydroxyethyl cellulose (OS-EHEC) or any combination or mixture of these.

In an embodiment, the fiber material further comprises a biobased and/or biodegradable plasticizer blended with the cellulose ether, in particular at least one of acetyl tributyl citrate (ATBC), triethyl citrate (TEC), triacetin, and dibutyl sebacetate (DBS).

The term “plasticizer”, as used herein, may particularly denote a substance that is added to the fiber material to make it softer and more flexible. Adding a plasticizer to the fiber material may achieve at least one of the following: to increase its plasticity, to decrease its viscosity, to decrease friction during its handling, and to adjust its melting behavior, in particular its melting temperature or softening temperature and/or its stretchability. Plasticity, also known as plastic deformation, may denote the ability of a material to undergo permanent deformation, i.e. a non-reversible change of shape in response to applied forces.

The type and/or quantity of the plasticizer may be adapted to adjust a melting or softening behavior of the fiber material, in particular in view of specific fiber generating processes such as a meltblown process or a spunbond process. The amount of the plasticizer may be in the range from 0 to 40 wt.-%, in particular in the range from 5 to 30 wt.-%, for example 20 wt.-%, based on the total weight of the fiber material. The viscosity of the plasticizer, measured for example according to DIN EN ISO 3219, may differ by less than 20%, in particular by less than 10%, from the viscosity of the cellulose ether.

Some of the processes for generating fibers and/or nonwoven webs may require a plasticizer. For example, fiber raw material without a plasticizer may not pass through an extrusion hole of certain fiber generating machinery. ATBC, due to its low solubility in water, may be advantageous for certain applications, e.g. in food and beverage processing, where water is often present. The substantial solubility of TEC in water may be advantageous in terms of recyclability.

In an embodiment, the fiber material further comprises a biobased and/or biodegradable filler material blended with the cellulose ether, in particular at least one polymeric filler material selected from the group consisting of starch, thermoplastic starch (TPS), a polyhydroxyalkanoate (PHA), polybutylene succinate (PBS), polybutylene adipate terephthalate (PBAT), polylactide (PLA), hydroxypropylmethyl cellulose (HPMC), methyl cellulose (MC), and a thermoplastic cellulose acetate and/or at least one of a mineral-based filler material selected from the group consisting of calcium carbonate (CaCO₃), titanium dioxide (TiO₂), and a silicon oxide (SiOₓ).

The term “filler material”, as used herein, may particularly denote any material that is added to the fiber material to adjust or improve certain properties of the fiber material, to reduce cost, or a mixture of both. As used herein, the term may particularly denote a material that is primarily added to reduce cost. For example, starch, TPS, and PHA may be cheaper than cellulose ethers, in particular cheaper than ethyl cellulose. Thus, overall cost may be reduced by adding a substantial amount of such filler materials. For example, the amount of filler material may be in the range from 20 to 90 wt.-%, in particular in the range from 30 to 80 wt.-%, based on the total weight of the fiber material, in particular the fiber raw material. Potentially, filler materials such as starch, TPS, and PHA may also be useful for adjusting melting or softening behavior of the fiber material, though to a lesser extent than by means of a plasticizer.

The terms “biodegradable” or “compostable”, as used herein, may particularly denote that the material concerned, such as the biodegradable filler material, a corresponding biodegradable fiber raw material, biodegradable fiber or biodegradable fabric, complies at least with the requirements for industrial compostability, for instance in accordance with at least one of EN 13432, EN 14995, ASTM D5988-18, ASTM D6400-19 and ASTM D6868-19, and preferably also with the requirements for home compostability, for instance in accordance with draft prEN 17427, and may preferably also be marine biodegradable, for instance in accordance with ASTM D6691-17. The term “marine biodegradable”, as used herein, may particularly mean that the material biodegrades by more than 90% by weight within 12-month storage in sea water at min. 15° C. and exposure to daylight.

The terms “biobased” or “bio-derived”, as used herein, may particularly denote that the material concerned, such as the biobased filler material, a corresponding biobased fiber raw material, biobased fiber or biobased fabric, can be derived from material of biological or natural origin, in particular from plants or other renewable entities, rather than fossil sources.

In an embodiment, the amount of the cellulose ether is in the range from 10 to 60 wt.-%, in particular in the range from 20 to 40 wt.-%, or in the range from 60 to 100 wt.-%, in particular in the range from 90 to 100 wt.-%, in particular 100 wt.-%, based on the total weight of the fiber material.

The amount of the plasticizer may be in the range from 0 to 40 wt.-%, in particular in the range from 5 to 30 wt.-%, for example 20 wt.-%, based on the total weight of the fiber material. The required amount of the plasticizer may depend on the technology used for producing fibers from the fiber raw material. The amount of the filler material may account, at least substantially account, for the remaining portion of the fiber material. Fiber material, as used herein, may refer to the fiber raw material and/or to the material of the finished fiber, either in isolation or when integrated into the nonwoven web.

A lower bound for the amount of the cellulose ether of 10 or 20 wt.-% may ensure that the fiber material can be turned into fiber by at least some fiber generating technology such as a meltextrusion process. On the other hand, an upper bound of 40 or 60 wt.-% may be advantageous for reducing overall cost, because plasticizers and/or filler materials accounting for the remaining portion of the fiber material may be cheaper than the cellulose ether. However, if high purity of the fiber material is desired, an amount of the cellulose ether close to 100 wt.-% may be advantageous.

In an embodiment, the average length of the fibers is in the range from 1 mm to 100 mm and/or the average coarseness of the fibers is in the range from 0.5 to 10 dtex.

The fibers may be short-cut fibers, staple fibers and/or endless fibers. Staple fibers may have a discrete or characteristic length with potentially some limited variation of fiber length. Like short-cut fibers, staple fibers may be cut, but they may be longer than short-cut fibers. Endless fibers may have arbitrary length.

For example, the average length of the fibers may be in the range from 3 mm to 80 mm, in particular from 5 to 70 mm, in particular from 10 to 65 mm, in particular from 15 to 60 mm, in particular from 18 to 50 mm, in particular from 20 to 40 mm. The average length of the fibers, in particular short-cut fibers, may be in the range from 1 mm to 12 mm, in particular from 3 mm to 10 mm or from 3 mm to 8 mm.

For example, the average coarseness of the fibers may be in the range from 0.5 to 10 dtex, in particular from 0.5 to 4.0 dtex or from 1.0 to 10 dtex, in particular 1.0 to 2.5 dtex. The coarseness of a fiber may be defined as the weight per unit length of the fiber (1 dtex=1g/1000 m).

These fiber characteristics may reflect advantageous processes such as meltextrusion processes of producing fibers from a material comprising a cellulose ether.

In an embodiment, the fabric comprises a plurality of layers, wherein a layer of the plurality of layers comprises the nonwoven web. The fabric may consist of two, three, four, five or more than five layers, in particular more than ten layers or even more than a hundred layers. More than one layer may comprise a nonwoven web as described herein. One of the layers may be a substrate to which the nonwoven web has been applied. A multilayered structure may allow to adjust or finetune various properties of the fabric. For example, some layers may strengthen the fabric, other layers may adjust filtering characteristics.

The grammage of the layer comprising the nonwoven web may be in the range from 1 g/m² to 50 g/m², in particular from 1 g/m² to 20 g/m², in particular 2 g/m² to 15 g/m². The grammage may also be greater than 50 g/m². The grammage or basis weight of a layer or the fabric may be determined in accordance with TAPPI T 410 (om-19).

In an embodiment, the fibers are arranged randomly. This feature may result from advantageous methods of producing a nonwoven web such as a meltblown process or a spunbond process.

In an embodiment, the fiber material and/or the fibers and/or the fabric are biobased and/or biodegradable.

In a further aspect, the present invention relates to a fiber made of a fiber material comprising a cellulose ether.

In a further aspect, the present invention relates to a method of producing a fabric, wherein the method comprises the steps of: (i) providing a fiber material, in particular a fiber raw material, comprising a cellulose ether; (ii) generating fibers from the fiber material; and (iii) arranging the fibers to form a nonwoven web.

The fibers may be generated by meltspinning, solution spinning, electrospinning, microfluidic spinning or any other fiber generating process. The step of arranging the fibers may include preliminarily arranging the fibers, in particular for storage and/or transport, and, thereafter, rearranging the fibers to form the nonwoven web. For example, the fibers may be preliminarily arranged at the end of the fiber generating process, e.g. on a roll and/or in a container or box. The preliminarily arranged fibers may, but need not form a nonwoven web. The preliminarily arranged fibers may not be bonded to each other or may be bonded to lesser extent than in the nonwoven web. The step of generating the fibers may include cutting the fibers, in particular to predefined lengths, for example a staple length.

Finding biobased materials and corresponding processes suitable for producing fibers to form a nonwoven web or fabric is a challenging task. It has been found in experimental studies by the present inventors that, surprisingly, cellulose ethers constitute particularly adequate raw materials for forming fibers and corresponding nonwoven fabrics. Because fibers made of a material comprising a cellulose ether may have improved biodegradability compared with conventional fiber materials, the corresponding fabric may have an improved ecological impact. In addition, nonwoven webs and fabrics are typically produced and/or recycled more easily and at less cost compared with knitted or woven fabric.

In an embodiment, the step of arranging the fibers includes a spunlace process.

The term “spunlace process”, as used herein, may particularly denote a process, in which fibers are entangled by means of water jets. The term “entangled” may particularly denote a state of being at least partly intertwined, in particular to impart strength, such as tear strength or tensile strength, to the non-woven fabric. The spunlace process may be a bonding process for wet or dry fibrous webs, where fine, high-pressure jets of water penetrate the fibrous web and cause an entanglement of the fibers. Thereby, fabric integrity may be provided or improved. Spunlacing is sometimes also referred to as “hydroentanglement”.

The spunlace process may be combined with a meltextrusion process, in particular a meltblown process and/or a spunbond process, but may also be combined with an airlaid process and/or a wetlaid process.

In an embodiment, the fibers are entangled by needle punching. During needle punching, the biodegradable fibers may be mechanically intertwined by means of needles.

In an embodiment, the fibers are generated by a meltextrusion process, in particular a meltblown process and/or a spunbond process. The meltextrusion process may include the step of melting the fiber material.

The term “meltextrustion process”, as used herein, may particularly denote any process by which a fiber raw material is melted in order to extrude fibers therefrom. The basic spinning process of meltextrusion nonwovens, in particular spunbonded and meltblown nonwovens, may include a process with at least some of the following steps: that the polymer is melted into spinning melt, ejected from a spinneret hole at a certain temperature and pressure, cooled and drawn into filamentous fibers, then divided and laid on a belt or netting device, and consolidated into nonwovens. In view of this procedure, meltextrusion processes may also be referred to as “meltspinning processes”. An advantage of using meltextrusion or meltspinning processes may be that a solvent may not be needed in the spinning process ensuring a high purity of the spun fiber material.

Due to the characteristics of meltextrusion or meltspinning processes, only fiber material with high decomposition temperatures and low melt viscosities may be adequate in meltspinning. Thus, the range of biopolymers may be limited due to denaturation or decomposition of those sensitive materials. Surprisingly, cellulose ethers, in particular in combination with a plasticizer, have turned out suitable in this regard in experimental studies carried out by the present inventors.

The term “meltblown process”, as used herein, may particularly denote an extrusion of melted fibers through a spin net or die to form long thin fibers. As they fall from the spin net or die, the fibers may be stretched and cooled by passing hot air over them. By means of hot, fast-flowing air the fibers may be directly blown onto a moving substrate such as a moving belt, creating a self-bonded web. The hot air temperature may be close to the melting temperature of the fiber material. A meltblown process may be advantageous, because extremely fine fibers may be produced, in particular the fibers may be more fine than those resulting from a spunbond process. The fiber diameter may be a magnitude lower compared to the spunbond process. Due to the fine fibers, meltblown layers or fabrics may have advantageous filtering characteristics, e.g. being able to capture very fine particles.

The terms “spunbond process” or “spunlaid process”, as used herein, may particularly denote a process, in which fibers or filaments, which may be substantially endless, are spun from a molten mass or solution, i.e. the molten fiber raw material, and are then directly dispersed into a web by deflectors and/or air streams. A difference between the spunbond process and the meltblown process may be that in the spunbond process the hot air flow is at a cross flow to the emerging fiber, whereas in the melt-blown process hot air converges with the fiber as it emerges from the die. A spunbond process may be advantageous, because fibers with substantial intrinsic strength may be produced, in particular the intrinsic strength may be larger than in the case of meltblown fibers. Thus, spunbond fabrics may be stronger than corresponding meltblown fabrics and may even serve as support for meltblown fabrics.

In an embodiment, layers of meltblown nonwovens and spunbond nonwovens are combined. The resulting fabric may have sufficient intrinsic strength, but also advantageous filtering properties. For example, melt blown-spunbond multilayer fabrics, e.g. spunbond-meltblown (SM), spunbond-meltblown-spunbond (SMS), may be used in filtration applications.

In an embodiment, the steps of generating the fibers and of arranging the fibers form a continuous process. For example, the fibers may be arranged before having fully cooled.

The expression “forming a continuous process”, as used herein, may particularly mean the steps being carried out directly one after the other. It may also mean that the steps of generating the fibers and arranging the fibers form part of an integrated procedure or even of a one-step-process. For example, the fibers may be arranged before the step of generating the fibers is finished, e.g. because the fibers, when arranged, have not yet fully cooled. In this manner, the nonwoven web may be produced in a particularly efficient way requiring little time and/or machinery.

Alternatively, in an embodiment, the fibers may be stored for a certain period of time, before being arranged and/or the fibers may first be arranged in a preliminary manner, but then rearranged after a certain period of time.

In an embodiment, the steps of generating the fibers and of arranging the fibers may be carried out at least partly by the same machine or machinery.

In an embodiment, the method further comprises absorbing cellulosic material into and/or onto the nonwoven web, in particular at least one of microfibrillated cellulose (MFC), nanofibrillated cellulose (NFC), cellulosic pulp fibers and lyocell fibers. The cellulosic pulp fibers may be refined or nonrefined. The lyocell fibers may be refined or nonrefined.

In other words, the nonwoven web is used as a substrate and cellulosic material is absorbed into and/or onto the substrate. The cellulosic material may be absorbed by means of surfactants and/or using ultrasonic technology. Other techniques may be used as well for absorbing the cellulosic material. The cellulosic material may be absorbed to different depths of the nonwoven web. Absorbing the cellulosic material into and/or onto a substrate comprising the nonwoven web may be advantageous to add or to refine corresponding properties of the nonwoven web, e.g. filtering properties.

In an embodiment, the fibers are arranged on a substrate, in particular on at least one of an airlaid web, a wetlaid web, and a further nonwoven web. The substrate may be a paper-based web. The substrate may provide stability and/or strength. Thus, a multilayer biobased and/or biodegradable fabric may be provided with the substrate forming a first layer and the nonwoven web comprising the fibers forming a second layer.

In an embodiment, the fibers are arranged, in particular rearranged, by at least one of a wetlaid process and an airlaid process. For example, the fibers may first be preliminarily arranged, e.g. for storage and/or transport, and, thereafter, rearranged by the wetlaid process and/or the airlaid process. When preliminarily arranged, the fibers may, but need not form a nonwoven web. The fibers may be preliminarily arranged by a meltextrusion or meltspinning process, e.g. a meltblown process and/or a spunlaid process.

The term “wetlaid process”, as used herein, may particularly denote a process, in which the generated fibers, potentially in addition with other types of fibers, are suspended in a fluid, in particular water. The fibers may be mixed with viscose and/or wood pulp. Afterwards, the water-fiber-or the water-pulp-dispersion may be continuously deposited on a belt or a forming wire. The water may then be removed, in particular sucked off.

The term “airlaid process”, as used herein, may particularly denote a process, in which a gas, in particular air, is used as a carrying medium for the fibers. Thus, the fibers may be arranged by the gas to form the nonwoven web. Conventional airlaid processes are described for instance in U.S. Pat. No. 3,905,864 A and EP 0958419 A1, the disclosures of which are incorporated herein by reference.

Fibers made of a fiber material comprising cellulose ether, in particular short-cut fibers, may be blended in pulp fibers such as wood pulp fibers, in particular to create or improve sealing performance of the fabric. Wood pulp (fibers) may comprise softwood pulp and/or hardwood pulp, i.e. pulp fibers from softwood species such as pine or fir and/or pulp fibers from hardwood species such as birch. The wood pulp may be refined, such as beaten and/or delignified.

In a further aspect, the present invention relates to a fabric obtainable by the method described herein.

### EXAMPLES

### Example 1

A layered fabric with two layers was produced, wherein ethyl cellulose fibers were meltblown on a wetlaid substrate:
bio-web layer 2: Meltblown, Ethocel™ with additives, 5 g/m2 grammage, 1-5 μm layer thickness;
bio-web layer 1: Wet laid native cellulosic pulp fiber refined, 8 g/m² grammage (50% Abaca 25°SR, SW=soft wood/HW=hard wood 35°SR, additives). Ethocel™ is an ethyl cellulose polymer resin provided by DuPont. Additives used in bio-web layer 2 were ATBC or TEC as plasticizer and, optionally, PHA or TPS as filler material. °SR is the refining degree.

### Example 2

A single-layer fabric was produced, wherein an additional filler material was absorbed into a meltblown nonwoven web comprising ethyl cellulose fibers:
bio-filler: MFC absorbed in meltblown web;
bio-web layer: Meltblown, Ethocel™ with additives, 12 g/m² grammage, 1-5 μm layer thickness.

Additives used in the bio-web layer were ATBC or TEC as plasticizer and, optionally, PHA or TPS as filler material.

### Example 3

A two-layer fabric was produced, wherein an additional filler material was absorbed into a meltblown nonwoven web comprising ethyl cellulose fibers:
bio-filler: MFC absorbed in meltblown web;
bio-web layer 2: Meltblown, Ethocel™ with additives, 12 g/m² grammage, 1-5 μm layer thickness;
bio-web layer 1: Biodegradable and/or biobased spunbond glucane web.

Additives used in the bio-web layer 2 were ATBC or TEC as plasticizer and, optionally, PHA or TPS as filler material.

While the present invention has been described in detail by way of specific embodiments and examples, the invention is not limited thereto and various alterations and modifications are possible, without departing from the scope of the invention.

1. A fabric comprising:
a plurality of fibers,
wherein the plurality of fibers are made of a fiber material comprising a cellulose ether,
wherein the plurality of fibers form a nonwoven web.

2. The fabric of claim 1, wherein the cellulose ether is ethyl cellulose.

3. The fabric of claim 1, wherein the fiber material further comprises a biobased and/or biodegradable plasticizer blended with the cellulose ether.

4. The fabric of claim 1, wherein the fiber material further comprises a biobased and/or biodegradable filler material blended with the cellulose ether.

5. The fabric of claim 1, wherein the amount of the cellulose ether is in the range from 10 to 60 wt.-%, based on the total weight of the fiber material.

6. The fabric of claim 1, wherein the average length of the fibers is in the range from 1 mm to 100 mm and/or the average coarseness of the fibers is in the range from 0.5 to 10 dtex.

7. The fabric of claim 1, comprising a plurality of layers, wherein a layer of the plurality of layers comprises the nonwoven web.

8. A method of producing a fabric, the method comprising the steps of:
providing a fiber material comprising a cellulose ether;
generating fibers from the fiber material; and
arranging the fibers to form a nonwoven web.

9. The method of claim 8, wherein the step of arranging the fibers includes a spunlace process.

10. The method of claim 8, wherein the fibers are generated by a meltextrusion process.

11. The method of claim 8, wherein the steps of generating the fibers and of arranging the fibers form a continuous process.

12. The method of claim 8, further comprising;
absorbing cellulosic material into and/or onto the nonwoven web.

13. The method of claim 8, wherein the fibers are arranged on a substrate selected from the group consisting of an airlaid web, a wetlaid web, and a further nonwoven web.

14. The method of claim 8, wherein the fibers are arranged by at least one of a wetlaid process and an airlaid process.

15. A fabric obtainable by the method of claim 8.

16. The fabric of claim 3, wherein the biobased and/or biodegradable plasticizer has a viscosity, measured according to DIN EN ISO 3219, that differs by less than 20% the viscosity of the cellulose ether.

17. The fabric of claim 3, wherein the biobased and/or biodegradable plasticizer comprises at least one of acetyl tributyl citrate (ATBC), triethyl citrate (TEC), triacetin, and dibutyl sebacate (DBS).

18. The fabric of claim 4, wherein the biobased and/or biodegradable filler material comprises at least one polymeric filler material selected from the group consisting of starch, thermoplastic starch (TPS), a polyhydroxyalkanoate (PHA), polybutylene succinate (PBS), polybutylene adipate terephthalate (PBAT), polylactide (PLA), hydroxypropylmethyl cellulose (HPMC), methyl cellulose (MC), and a thermoplastic cellulose acetate and/or at least one mineral-based filler material selected from the group consisting of calcium carbonate (CaCO₃), titanium dioxide (TiO₂), and a silicon oxide (SiOₓ).

19. The method of claim 10, wherein the fibers are generated by a meltblown process and/or a spunbond process.

20. The method of claim 12, wherein the cellulosic material comprises at least one of microfibrillated cellulose (MFC), nanofibrillated cellulose (NFC), cellulosic pulp fibers, and lyocell fibers.
